(19) United States
(12) Patent Application Publication
(10) Pub. No.: US 2026/0176880 A1
(43) Pub. Date: Jun. 25, 2026

(54) Decorative Floor Covering Element, and Method of Producing Such an Element

(71) Applicant: i4F Licensing NV, Turnhout (BE)

(72) Inventor: Eddy Alberic Boucké, Turnhout (BE)

(21) Appl. No.: 19/143,474

(22) PCT Filed: Dec. 28, 2023
(86) PCT No.: PCT/EP2023/087940

§ 371 Date: Jun. 26, 2025

(30) Foreign Application Priority Data
Dec. 28, 2022 (NL) 2033859

(51) Int. Cl. E04F 15/10; B32B 3/06; B32B 7/04; B32B 25/08; B32B 27/08; B32B 27/20; E04F 15/02

(52) U.S. Cl. CPC E04F 15/107; B32B 3/06; B32B 7/04; B32B 25/08; B32B 27/08; B32B 27/20; E04F 15/02038; B32B 2250/04; B32B 2250/24; B32B 2307/7376; B32B 2471/00; E04F 2201/0138; E04F 2201/023; E04F 2201/043

(57) ABSTRACT

The invention relates to a decorative covering element, in particular a decorative floor covering element, such as a floor panel, a decorative wall covering element, such as a wall panel, a decorative ceiling covering element, such as a ceiling panel, wall panel, or ceiling panel. The invention further relates to a method of post-use handling of a recollected decorative covering element, in particular a floor covering element, according to the invention.

### CROSS-REFERENCE TO RELATED APPLICATIONS

This application is the United States national phase of International Patent Application No. PCT/EP2023/087940 filed Dec. 28, 2023, and claims priority to The Netherlands Patent Application No. 2033859 filed Dec. 28, 2022, the disclosures of which are hereby incorporated by reference in their entireties.

### BACKGROUND OF THE INVENTION

### Field of the Invention

The invention relates to a decorative covering element, in particular a decorative floor covering element, such as a floor panel, a decorative wall covering element, such as a wall panel, a decorative ceiling covering element, such as a ceiling panel, wall panel, or ceiling panel. The invention further relates to a method of post-use handling of a recollected decorative covering element, in particular a floor covering element, according to the invention.

### Description of Related Art

The flooring industry uses mainly traditional core materials for manufacturing (laminated) floor tiles. Examples of commonly used materials for composing a core layer of the known floor tiles are high density fibreboard (HDF) which can be merged together by a formaldehyde or phenol-based resin, heterogeneous or homogeneous polyvinyl chloride (PVC) which may possibly comprise any plasticizers, pieces of solid hardwood, or layers of veneers glued together, and fired and glazed clay such as ceramic and porcelain tiles. The purpose of use of these materials depends mainly on their material properties such as impact resistance, rigidity, acoustic performance and/or appearance. Often at least one backing layer is affixed to the core, which backing layer may act as balancing layer. An example of such a balancing layer is a layer which comprises lignocellulose and a cured resin. The backing layer may also be formed by an acoustic layer, which is usually composed of a low density foamed layer of ethylene-vinyl acetate (EVA) or cork.

With increasing environmental concerns and regulations, there is a drive toward environmentally benign methods to post-consumer recycle layers of the floor tiles. However, a proper recycling of these layers, in particular when these layers are composed of different materials and/or polymers, requires separation these layers which turns out to be difficult in practice. Adhesive, often polyurethane (PU) adhesives, which are used to mutually adhere the layers are aimed to create a high adhesive strength and achieve a durable bonding of the layers, which renders it difficult or even impossible to realize a post-consumer proper delamination of said layers, and without damaging the layers. Consequently, the recycling of the floor tiles known from the art is compromised by the fact that a clean separation of the layers is not achievable, which results in a contamination of each of the separated streams of basic materials that is processed during recycling. Moreover, PU adhesives, often used as two-component or single-component adhesives, are based on the chemical reaction of different ingredients, which makes working with PU adhesive not without risk. To the contrary, PU adhesive are known for their health hazard, which is the reason to subject these adhesives to safety regulations, such as the German Chemicals Prohibition Ordinance, and may in most jurisdictions not be sold to persons under 18 years of age, wherein specific safety measures are prescribed for using PU adhesives.

### SUMMARY OF THE INVENTION

It is a first object to provide an improved decorative covering element, in particular decorative floor covering element, which can be processed post-use in an improved manner.

It is a second object to provide an improved decorative covering element, in particular decorative floor covering element, of which parts can be recycled more easily.

It is a third object to provide an improved decorative covering element, in particular decorative floor covering element, which can be produced in a relatively safe manner.

In order to meet at least one of the above objects, the invention provides a decorative covering element according to the preamble, comprising:
at least one core layer,
a decorative top structure affixed, either directly or indirectly, on an upper side of said core layer,
a backing layer affixed, indirectly or indirectly, on a lower side of said core layer by means of an intermediate tie layer and/or a decorative surface layer affixed, directly or indirectly, on an upper side of said core layer by means of an intermediate tie layer, wherein said (at least one) tie layer is compatible with both neighbouring layers, such as said core layer and said backing layer and/or said core layer and said decorative surface layer, and wherein said tie layer is hydrogen bonded to at least one of said neighbouring layers, such as at least one of said core layer and said backing layer and/or at least one of said core layer and decorative surface layer and/or at least one of said backing layer and another neighbouring layer.

The decorative covering element according to the invention may be decorative floor covering element, such as a floor panel, a decorative wall covering element, such as a wall panel, a decorative ceiling covering element, such as a ceiling panel, wall panel, or ceiling panel, and will hereinafter simply be referred to as floor covering element. An important advantage of the floor covering element according to the invention is that the traditional adhesives to chemically bond a backing element onto a core layer have been replaced by said tie layer to bond the backing layer onto the core layer. The tie layer, which may be an extremely thin layer, in particular a monomolecular layer, has the property to sufficiently strongly adhere the backing layer onto the core layer, at least partially based upon formation of the hydrogen bonds between the tie layer and at least one adjacent layer. Due to the hydrogen bridge formation relatively weak, but still, for the intended normal use of the floor covering element, sufficiently strong bonds are formed between the tie layer and at least one adjacent layer are formed. These weaker bonding of the backing layer to the core layer facilitates post-use separation of these layers. This separation can normally easily be achieved by sufficiently heating the floor covering element, typically to a temperature of between 80 and 150 degrees Celsius, followed by a pulling apart of the layers to be separated. After separation, the layers can be separately processed and separated recycled into new products, among which new decorative floor covering elements. Since the tie layer can be extremely thin, and even monomolecular thin as indicated above, no visible residue and no substantial residue will remain after post-use layer separation. Moreover, the tie layer normally does not mechanically penetrate into a porous neighbouring layer, such as the core layer, which keeps the core layer unfouled and pure, which facilitates post-use recycling of the core layer after being separated from the backing layer, and preferably also after being separated from the decorative top structure. The tie layer is normally used as compatibilizer to adhere non-compatible layers to each other. Non-compatible layers are layers which have different material compositions, in particular are based upon different (main) polymers, respectively, which therefore have the tendency not to adhere to each by means of fusion, and which therefore require an additional layer to realize the interlayer bonding. An additional advantage of using a tie layer is that the nature of the substance of the tie layer is less health hazardous which makes it relatively safe to work with. As will be explained below, normally at least one of the layers to be bonded, such as the backing layer, will be pre-treated, and in particular modified at least at its surface to be adhered to the other layer, such as core layer, to facilitate an easy and smooth bonding between said two layers. Creating the hydrogen bonding between the tie layer and an adjacent layer, such as the core layer, is normally realized by pressing the layer to be adhered onto each other for a short period of time at elevated temperature. In fact, the process conditions used for lamination may be comparable to the process conditions used for delamination, apart from the direction in which the forces are applied. More in particular, during lamination the layers to be adhered are pressed onto and towards each other, while during delamination the layers to be separated are pulled apart and/or shifted with respect to each other.

The core layer may comprise a (main) polymer, preferably a thermoplastic material, which is more preferably chosen from the group consisting of: PVC, PET, PETG (PP, PS, thermoplastic polyurethane (TPU), PE, in particular MDPE and/or HDPE; and combinations thereof.

Preferably, at least one core layer and/or said backing layer (and/or at least one decorative layer (applied on top of the core layer)) comprises at least one thermoplastic material is chosen from the group consisting of: polypropylene (PP), thermoplastic polyurethane (TPU), polystyrene (PS), polyethylene (PE), polyethylene terephthalate (PET), polyethylene terephthalate glycol (PETG), polyvinyl chloride (PVC), and a furan resin. At least one thermoplastic based layer, such as a core layer, may either be solid or foamed. Although the decorative layer may also be foamed, this layer is in most embodiment a solid (unfoamed) layer, and more in particular a solid film. The polymer used in a floor covering element layer, preferably an extruded floor covering element layer, is preferably at least partially composed of a polymer formed by a mixture of virgin polymer material, recycled polymer material, or a combination of virgin and recycled polymer material. Preferably, at least one the polymer used in a floor covering element layer, preferably an extruded floor covering element layer, is preferably enriched with at least one additive, preferably at least one additive chosen from the group consisting of: talc, chalk, wood, calcium carbonate, titanium dioxide, calcined clay, porcelain, glass particles, glass fibres, carbon particles, silicon particular, a(nother) mineral filler, rice, textile fibers, such as cotton fibers, and another natural filler.

Preferably, said furan resin optionally used in at least one core layer and/or at least one decorative top layer is at least one furan resin selected from the group consisting of: poly(ethylene 2,5-furandicarboxylate) (PEF), poly(propylene 2,5-furandicarboxylate) (PPF), poly(butylene 2,5-furandicarboxylate) (PBF), poly(1,4-cyclohexanedimethylene 2,5-furandicarboxylate) (PCHDMF), poly trimethylene furan dicarboxylate) (PTF), poly (neopentyl 2,5-furandicarboxylate) (PNF) and mixtures thereof. The furan resin optionally used in the floor covering element according to the invention may be a homopolymer or a copolymer, such as random or block copolymers. An example of such a furan (based) copolymer is poly(ethylene 2,5-thiophenedicarboxylate-co-2,5-furandicarboxylate) (PEThF).

PS may be in the form of expanded PS (EPS) in order to further reduce the density of the floor covering element, which leads to a saving of costs and facilitates handling of the panels. Also in case another thermoplastic material is used, this material may be applied in foamed state in the core to reduce the density and costs. Nevertheless, it is also imaginable that the thermoplastic material used as main polymer is a solid polymer (i.e. an unfoamed polymer). Preferably, at least a fraction of the polymer used may be formed by recycled thermoplastic, such a recycled PVC or recycled PU. It is conceivable that a mix of virgin and recycled thermoplastic material is used to compose at least a part of the core. Instead of the thermoplastic material, also a thermoset polymer may be used, such as thermoset polyurethane.

Preferably, the core layer comprises at least one filler at least partially formed of molecules comprising at least one hydroxyl group (O—H group) and/or at least one amino group (N—H group) and/or at least one fluorine group (F—H) group. These functional groups have to be ability to provide the filler dipole properties, which allows the formation of hydrogen bridges between these functional groups present and exposed at the surface of the core layer and a comparable functional group of the tie layer. The hydroxyl group may make part of a carboxylic group. Preferably, the filler comprises lignin and/or cellulose and/or hemicellulose. Preferably, the core layer comprises at least one natural filler at least partially formed of molecules comprising at least one hydroxyl group, wherein at least one of such a natural filler is preferably chosen from the group consisting of: wood, paper, cork, bamboo, hemp, linen, flax, jute, sisal, coconut fibers, banana fibers, cotton, felt, and leather. The filler may be formed by fibres, such as glass fibers or synthetic or genuine leather fibers, and/or may be formed by dust-like particles. Here, the expression “dust” is understood as small dust-like particles (powder), like bamboo dust, wood dust, cork dust, or non-wood dust, like mineral dust, stone powder, in particular cement, and combinations thereof. The average particle size of the dust is preferably between 14 and 20 micron, more preferably between 16 and 18 micron.

Additionally or alternatively, a side of the core layer facing the backing layer may be provided with at least one coating and/or layer which at least partially formed of molecules comprising at least one hydroxyl group (O—H group) and/or at least one amino group (N—H group) and/or at least one fluorine group (F—H) group. This could also lead to the formation of hydrogen bridges between these functional groups present and exposed at the surface of the layer covering core layer and a comparable functional group of the tie layer.

It is imaginable that the core layer comprises at least one mineral or synthetic filler at least partially formed of molecules comprising at least one hydroxyl group and/or at least one amino group. In this case, it is for example possible that the core layer comprises mesoporous silica particles, porous calcium carbonate particles, and/or porous calcium phosphate particles, wherein said particles are loaded with at least one substance comprising at least one amino group and/or at least one hydroxyl group, such as sodium dihydrogen phosphate dihydrate and/or disodium hydrogen phosphate heptahydrate. Typically said one or more of said or other hydrates are deposited onto the outer surface of the mineral or synthetic fillers. This deposition leads to a hydrogen bond susceptible shell or coating of the mineral or synthetic filler. By using porous mineral or synthetic particles as filler, the surface area of these fillers is increased significantly, which also provides more ability to form (more) hydrogen bonds with the tie layer.

Although the tie layer is based upon formation of (non-covalent) hydrogen bonds between the tie layer and at least one adjacent layer to be adhered to the tie layer, this does not exclude the formation of covalent bonds, ionic bonds, metallic bonds, van der Waals bonds between the tie layer and said adjacent layer(s). It may even be preferred that at least one side of the tie layer is both hydrogen bonded and covalently bonded to at least one of said core layer and said backing layer. This provides slightly more firm adhesive forces between the layers, while still being sufficiently weak to post-use separate the layers in a smooth and efficient manner. The ratio between the number non-covalent bonds and the number covalent bonds at a specific interface of the tie layer and said adjacent layer is preferably between 1:2 and 2:1, and is more preferably approximately 1:1. This latter can, for example be realized by composing at least a part of the tie layer of maleic anhydride, a molecule which is configured to create one non-covalent hydrogen bond and one covalent bond with one or more, like two, hydroxyl groups of an adjacent layer, as depicted below.

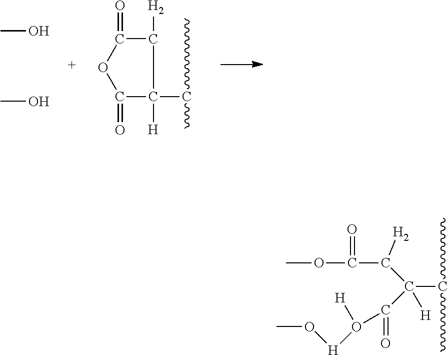

As depicted above, the maleic anhydride is covalently bonded to a backbone of a main polymer (schematically depicted as meandered line), for example of the backing layer, and therefore in fact forms a side chain of said main polymer. Hence, said backing layer preferably comprises at least one polymer, and wherein at least a fraction of tie layer molecules are grafted onto said polymer of the backing layer. This grafting process may take place in advance and is typically performed by specialized companies. In the above bonding mechanism, the weakest link in the laminate of core layer, tie layer, and backing layer (onto which the tie layer is grafted), will be the hydrogen bond based interface between the core layer and the backing layer. Here, the backing layer and the tie layer grafted onto said backing layer may be considered as single (assembled) layer. Preferably, the amount of tie layer molecules grated onto the backing layer is at least 1.0% by weight of the backing layer including the grafted tie layer molecules. Additionally or alternatively, it is also imaginable that the tie layer is grafted onto a surface of the core layer. It is even imaginable that the (lower surface of the) core layer is provided with a, preferably grafted, core tie layer, and the (upper surface of the) backing layer is provided with a, preferably, grafted, backing tie layer, wherein said core tie layer and said backing tie layer are configured to be hydrogen bonded to each other.

As depicted above, the covalent bonding between maleic anhydride and the hydroxyl groups is formed by a chemical reaction during which the ring of the maleic anhydride group is opened and bonded to the alcohol groups accompanied by a hydrogen atom transfer from one of the alcohol groups to the maleic acid group. Hence, the maleic anhydride is configured to act as hydrogen acceptor, wherein an alcohol group of an adjacent layer may act as hydrogen donor. The tie layer may therefore not only be configured to be hydrogen bonded to at least one of said core layer and said backing layer, but may also be reactively bonded to at least one of said core layer and said backing layer, wherein this reactive bonding is preferably based upon (or goes together with) a hydrogen atom transfer, also referred to as transfer hydrogenation. Such as reactive tie layer preferably comprises a substance chosen from the group consisting of: a polyanhydride; a maleic anhydride; a polymaleic anhydride; and a copolymer of said polyanhydride or said polymaleic anhydride with either an olefin, an ethyl vinyl acetate, and/or with ethylene acrylate.

The chemical reaction between the reactive tie layer and at least one of said core layer and said backing layer (or any other adjacent layer) yields linear polyesters. Although a separate transfer hydrogenation catalyst may be used to promote this chemical reaction, such as a catalyst comprising cobalt, nickel, copper, palladium, platinum, ruthenium, iridium, a Group 6 metal, or combinations thereof, such a separate catalyst may not be needed in practice as heating the tie layer, such as to temperatures of 70-120 degrees Celsius, will often be sufficient to initiate the reaction.

The thickness of the backing layer, preferably of the tie layer modified backing layer, is preferably 0.2-3 mm. This thickness is typically sufficient to provide the decorative covering element the desired comfort and/or acoustic and/or balancing properties.

In a preferred embodiment, said backing layer comprises rubber, in particular natural rubber, and wherein said tie layer is bonded to said rubber. Preferably, said backing layer is at least partially composed of at least one partially UV cured natural rubber comprising rubber chains at least partially crosslinked by at least one organic, preferably sulphur-free, crosslinking agent, and which natural rubber comprises at least one photo-initiator and/or at least one photo-initiator derivative. Rubber, in particular natural rubber, is durable, abrasion resistant, vibration dampening, and costs less than many alternative synthetic polymers, like EVA. Moreover, natural rubber boasts a large stretch ratio, high resilience and is extremely waterproof. Since the rubber is cured (vulcanized) by using ultraviolet (UV) radiation, the rubber becomes at least partially UV cured. This curing system does not require, and preferably does not use sulphur and traditional sulphur based curing systems. Allergenic reactions are associated with sulphur comprising chemicals used during sulphur-based (pre) vulcanization. Since the UV cured natural rubber used in the floor covering element according to the invention does not require, and preferably does not use, any sulphur to crosslink rubber chain, the chance of allergenic reactions occurring as a result of the use of the floor covering element, in particular during touching the exposed backing layer, is reduced significantly. Furthermore, the natural rubber used in the backing layer is preferably an unfoamed (solid) layer, which inhibits microbial growth, and which makes this material more microbial resistant compared to porous and/or foamed materials, like EVA. A further advantage of the use of natural rubber in the backing layer of the floor covering element according to the invention is that the natural rubber can be given, dependent on the state of cure (crosslinking density), a surface tackiness, which allows the rubber to fixate the floor covering element with respect to a subfloor, which is in favour of the stability of a floor covering composed of a plurality of such floor covering elements.

Preferably, said natural rubber comprises rubber chains at least partially crosslinked by at least one branched organic, preferably sulphur-free, crosslinking agent. Preferably, each cross-links comprises a backbone which comprises at least five carbon atoms, and optionally oxygen atoms. This creates sufficient space in between the rubber chains, also to accommodate optional side branches of the crosslinks. As indicated above, preferably, said natural rubber comprises rubber chains at least partially crosslinked by at least one, preferably branched, organic, sulphur-free crosslinking agent.

Said natural rubber preferably comprises at least one photo-initiator chosen from the group consisting of: α-hydroxyphenylketone, 2,2-dimethoxy-2-phenyl acetophenone, triarylphosphine oxide, bisacylphosphine oxide, bis(2,4,6-trimethylbenzoyl)-phenylphosphineoxide, 2-hydroxy-2-methyl-1-phenylpropanone. This latter compound is also known as Irgacure 1173 (and as Omnirad 1173), which can be obtained from BASF. It is imaginable that these compounds are still present in the natural rubber after UV curing. At least a fraction of these compounds (or any other suitable photo-initiator) will be cleaved, typically homolytically, into, radicals on absorbing UV light during UV curing. These radicals are suitable to react with the rubber chains and/or the crosslinking agent to initiate and/or propagate the crosslinking process. The aforementioned radicals will typically become part of the crosslinks in between the rubber chains. These radicals are considered as photo-initiator derivatives. Hence, the said crosslinking agent (in crosslinked state (crosslinking adjacent rubber chains)) preferably comprises at least one photo-initiator derivative. In case, 2-hydroxy-2-methyl-1-phenylpropanone is used, for example, as initial photo-initiator, then this molecule is cleaved by UV light into a benzoyl radical and an isopropanol radical. These reactive radicals are typically and preferably reacting with the crosslinking agent to become part—as benzoyl group and isopropanol group—of the crosslinking agent and/or of the crosslinking bridge based upon said crosslinking agent.

The crosslinking agent comprises and/or is based upon acrylate. Preferably, said crosslinking agent comprises and/or is based upon 1,9-bis(acryloyloxy)nonane. This latter preferred compound is suitable to form monoradicals and/or biradicals. Natural rubber chains typically comprises polyisoprene, preferably cis-1,4-polyisoprene. Hence, as an example, a UV based crosslinking mechanism (curing system), based upon cis-1,4-polyisoprene (natural rubber), 1,9-bis(acryloyloxy)nonane (crosslinking agent), and 2-hydroxy-2-methyl-1-phenylpropanone, could be described and depicted as follows. In a first step, absorption of UV light results in the formation of benzoyl and isopropanol radicals via homolytic cleavage of 2-hydroxy-2-methyl-1-phenylpropanone.

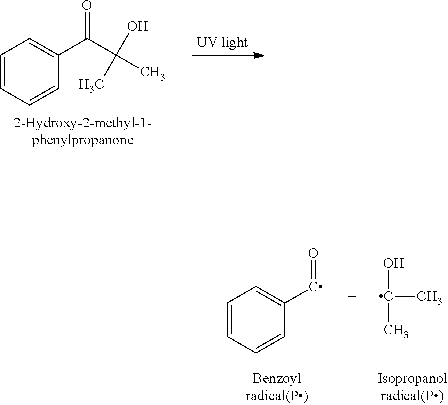

These radicals (P·) initiate (pre)vulcanization by attacking the C═C bonds of the nearest molecules of polyisoprene (rubber chains) and the crosslinking agent. The reaction between the radicals of the photo-initiator and the polyisoprene chains produces polymer radicals, whereas the reaction between the radicals of the photo-initiator and 1,9-bis(acryloyloxy)nonane generates products with one or two radical centres. These are the monoradical and the biradical, respectively.

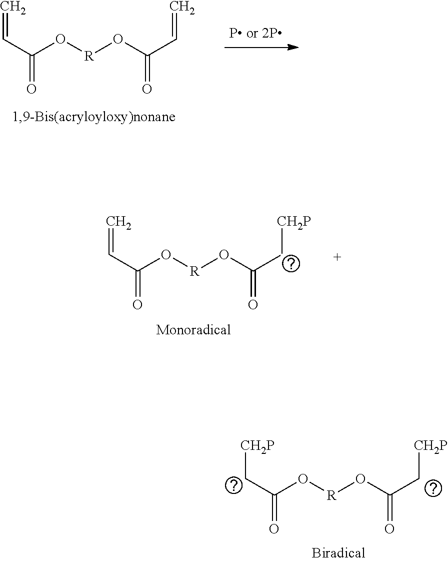

These crosslinking radicals can also react with polyisoprene to form cross-links between the polyisoprene chains.

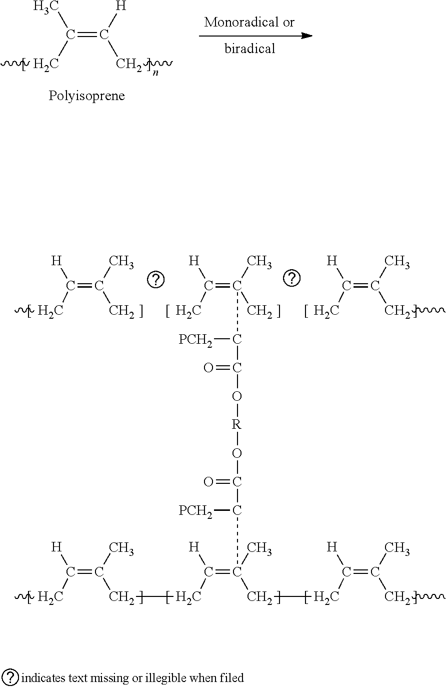

Preferably, the natural rubber of the backing layer has a dry rubber content (solid rubber content) of at least 40%, more preferably at least 50%, most preferably at least 60% by weight of the natural rubber. Such a dry rubber content provides the backing layer suitable properties for use in a backing layer of a floor covering element.

Preferably, at least a fraction of the natural rubber is obtained from a Hevea brasiliensis tree and/or Sf Ficus elastica tree. This is still the primary source of natural rubber today, but increased worldwide demand means that alternative sustainable sources are urgently required. The Russian dandelion (Taraxacum koksaghyz Rodin) is such an alternative because large amounts of natural rubber are produced in its root system. Hence, preferably, and even more preferably, at least a fraction of the natural rubber used in the backing layer is obtained from dandelions. Here, at least a fraction of the natural rubber is preferably obtained from a species of a Taraxacum genus, preferably at least one species chosen from the group consisting of: Taraxacum officianale, and Taraxacum kok-saghyz. Unlike Hevea rubber trees, Taraxacum kok-saghyz can be grown in temperate regions around the globe, including in North America and Russia.

Preferably, the tie layer comprises at least one substance chosen from the group consisting of: a polyacrylate or a polymethacrylate wherein the ester portion thereof has from 1 to about 12 carbon atoms; a blend of said polyacrylate or said polymethacrylate with a polyolefin; ethylene methyl acrylate copolymer; a polyanhydride; a maleic anhydride; a polymaleic anhydride; and a copolymer of said polyanhydride or said polymaleic anhydride with either an olefin, an ethyl vinyl acetate, and/or with ethylene acrylate. These compounds are typically well suitable to be applied and to form (sufficient) hydrogen bonds with an adjacent layer.

Preferably, the peel strength of the bonding between the backing layer and the core layer is at least 1.0, preferably at least 1.5 kN/m. Preferably, said peel strength is less than 5 KN/m to allow smooth post-use delamination. The peel strength is measured according to the a 90° peel test following D6862 (ASTM 2007b). Peel strength can be dividing the average recorded load by the peel width of a sample, wherein the average recorded load was determined by taking the mean load over the entire peel length.

Preferably, said tie layer and/or said backing layer have(s) a Vicat softening temperature measured according to method A50 as defined in ISO 306 between 80 and 150 degrees Celsius. This temperature range is also the preferred range for lamination during manufacturing of the decorative covering element in order to form the hydrogen bonds and optional covalent bonds, as well as for post-use delamination of the layers. Applying a tie layer and/or backing layer with a softening point fairly below 80 degrees Celsius, for example 70 degrees Celsius, is often disadvantageous since decorative covering elements can be heated by solar heat up to 70 degrees Celsius, which would affect the interlaying bonding of the floor covering element during normal use.

In a preferred embodiment, at least one intermediate layer is situated in between said tie layer and said core layer and/or situated in between said tie layer and said backing layer, wherein said intermediate layer preferably comprises a polymer, more preferably a thermoplastic polymer, and/or wherein said intermediate layer preferably represents a water impermeable layer. Such a layer may improve the water impermeability of the decorative covering element as such. Optionally, said polymer, in particular said thermoplastic polymer, of the intermediate layer may be grafted, at at least one side of the intermediate layer, by at least one tie layer to provide the polymer, if needed, the ability to form hydrogen bonds with at least one adjacent layer, such as the core layer and/or the backing layer and/or another tie layer. In case at least one intermediate layer is situated in between said tie layer and said core layer, said tie layer is preferably hydrogen bonded to said intermediate layer rather than to the core layer as such. Embodiments described or otherwise disclosed in this disclosure, which refer or relate to bonding of the tie layer to the core layer, the expression “core layer” may be replaced by “intermediate layer” in case such intermediate layer is applied and positioned in between the tie layer and the core layer. In case at least one intermediate layer is situated in between said tie layer and said backing layer, said tie layer is preferably hydrogen bonded to said intermediate layer rather than to the backing layer as such. Embodiments described or otherwise disclosed in this disclosure, which refer or relate to bonding of the tie layer to the backing layer, the expression “backing layer” may be replaced by “intermediate layer” in case such intermediate layer is applied and positioned in between the tie layer and the backing layer.

The decorative top structure is preferably at least partially transparent or translucent. The decorative top structure may be composed of a single layer, such as a printed decorative layer or a wear layer, but is typically composed of a plurality of layers. Preferably, the decorative top structure preferably comprises at least one printed, more preferably digitally printed, decorative layer and at least one transparent wear layer and/or transparent top coating covering said decorative layer. Said top coating is also referred to as lacquer layer. The wear layer is preferably made of polyvinyl chloride, polyurethane, and/or an acrylic resin. The decorative top structure may additionally comprise at least one back layer (primer layer) situated in between said decorative layer and the core, wherein said back layer is preferably made of a vinyl or polyurethane compound. A finishing layer may be applied in between the decorative layer and the wear layer. The decorative layer will be visible and will be used to provide the panel an attractive appearance. To this end, the decorative layer may have a design pattern, which can, for example be a wood grain design, a mineral grain design that resembles marble, granite or any other natural stone grain, or a colour pattern, colour blend or single colour to name just a few design possibilities. Alternatively, the decorative top structure may also be formed by a textile-based and/or carpet-based top structure and/or another decorative top structure, such as a ceramic tile or layer, stone tile or layer, glass tile or layer, wooden tile or layer, marble tile or layer. These tiles or layer may be, for example, adhered to the core layer by means of at least one intermediate layer, which may be a traditional adhesive layer and/or another tie later.

Preferably, the floor covering element comprises at a first pair of opposite edge complementary coupling profiles configured to interlock adjacent floor covering elements, and wherein the floor covering element preferably comprises at a second pair of opposite edge complementary further coupling profiles configured to interlock adjacent floor covering elements. More preferably, the floor covering element is a floor panel with a first panel edge comprising a first coupling profile, and a second panel edge comprising a complementary second coupling profile being designed to, either directly or indirectly, interlock adjacent panels. In case of direct interlocking, a coupling profile of a panel will directly co-act with a complementary coupling profile of an adjacent panel. In case of indirect interlocking, typically a separate coupling structure (connecting element) is used to mutually couple of plurality of panels, wherein a coupling profile of each of said panel is coupled to the coupling structure. In coupled condition, the floor panels may abut each other, or, alternatively, may be positioned at a distance from each other. The floor panel may further comprise a third panel edge comprising a third coupling profile, and a fourth panel edge comprising a complementary fourth coupling profile being designed to, either directly or indirectly, interlock adjacent panels. In a preferred embodiment, the first coupling profile and/or the third coupling profile comprises: an upward tongue, at least one upward flank lying at a distance from the upward tongue, an upward groove formed in between the upward tongue and the upward flank wherein the upward groove is adapted to receive at least a part of a downward tongue of a second coupling profile of an adjacent panel, and at least one first locking element, preferably provided at a distant side of the upward tongue facing away from the upward flank, and wherein the second coupling profile and/or the fourth coupling profile comprises: a first downward tongue, at least one first downward flank lying at a distance from the downward tongue, a first downward groove formed in between the downward tongue and the downward flank, wherein the downward groove is adapted to receive at least a part of an upward tongue of a first coupling profile of an adjacent panel, and at least one second locking element adapted for co-action with a first locking element of an adjacent panel, said second locking element preferably being provided at the downward flank. Preferably, the first locking element comprises a bulge and/or a recess, and wherein the second locking element comprises a bulge and/or a recess. The bulge is commonly adapted to be at least partially received in the recess of an adjacent coupled panel for the purpose of realizing a locked coupling, preferably a vertically locked coupling. It is also conceivable that the first locking element and the second locking are not formed by a bulge-recess combination, but by another combination of co-acting profiled surfaces and/or high-friction contact surfaces. In this latter embodiment, the at least one locking element of the first locking element and second locking element may be formed by a (flat of otherwise shaped) contact surface composed of a, optionally separate, plastic material configured to generate friction with the other locking element of another panel in engaged (coupled) condition.

At least a part of the tie layer may be extruded. It is imaginable that the entire tie layer is an extruded layer. It is imaginable that at least one of the core layer and the backing layer are extruded. In case a plurality of layers of the decorative covering elements is extruded, preferably these layers are (simultaneously) coextruded and preferably adhered directly downstream of the (co)extruding equipment.

It is imaginable that the decorative covering element comprises a plurality of tie layers. Preferably, each tie layer is situated in between different layers of the decorative covering element. For example, a first tie layer may be situated in between a core layer and a decorative layer applied on top of said core layer, while a second tie layer may be situated in between said core layer and the backing layer applied to a bottom side of the core layer. Different tie layers may have different compositions, which may, for example, be dependent on the layers to be bonded. It is also imaginable that different tie layers have the same composition. Hence, it may be preferred that the decorative floor covering element comprises at least one decorative surface layer affixed, directly or indirectly, on top of said core layer, wherein the at least one decorative surface layer is affixed on the upper side of said core layer by means of an intermediate tie layer, wherein said tie layer is compatible with said core layer and said decorative surface layer, and wherein said tie layer is hydrogen bonded, and optionally covalently bonded, to at least one of said core layer and said decorative surface layer.

The decorative surface layer may form part of a decorative top structure. This top structure may comprise a protective or wear layer situated above the decorative layer, to protect the decorative layer and possibly the core layers. The decorative layer may solely be formed by an ink layer representing a décor. The decorative layer may also comprises an ink carrying layer, such as a paper or polymeric film, carrying an ink layer representing the décor. Alternatively, it is imaginable that the decorative layer is a coloured layer, such as a polymer layer enriched with one or more colorants. The colour of the decorative layer may be a solid colour or may be composed of a plurality of colours. Typically, the décor defines a motif, an image, and/or a pattern, preferably composed of various colours. The décor is preferably printed, more preferably digitally printed, with (coloured) ink onto another floor covering element layer, such as an ink carrying layer, in particular a film, typically composed of paper and/or thermoplastic material. The décor contributes to the visual appearance (the “looks”) of the decorative floor covering element. One or more protective layers applied on top of the décor layer in order to protect the décor layer may have a textured upper surface or relief structure. Said textured upper surface or relief structure, also referred to as embossing structure, preferably matches the visuals of the décor at least partially, preferably entirely. This alignment is also referred as an alignment in register. This is for example attractive for imitated wood pattern, wherein the relief structure may comprise a plurality of impressions or cavities and/or grooves created by printing the relief structure, which are in register with the wood nerves and wood pores of the printed wood pattern. The location and depth of the impressions, cavities, and/or grooves, being a function of the wood nerves and wood pores of the printed pattern. The relief structure gives an improved and more realistic look-and-feel effect to the eventual decorative floor covering elements.

At least one protective layer may be a cured layer, such as an UV cured lacquer layer, which is preferably situated as uppermost layer. At least one other protective layer, preferably located underneath said cured layer (if applied) is configured to act as wear layer, and may be enriched with wear-resistant particles, such as aluminium oxide.

The decorative top structure preferably comprises at least one primer layer, at least one a décor layer on top of said primer layer, and at least one protective layer are applied on top of said décor layer. Preferably, said primer layer has white or whitish colour which will be in favour of the colour appearance (colour authenticity) of the printed décor applied, preferably directly, on top of said primer layer. The primer layer may for example comprise melamine cyanurate.

The decorative layer may have a thickness which is preferably situated between 0.03 and 0.2 mm. The decorative top structure preferably has a thickness between 0.2 and 1.2 mm, more preferably between 0.3 and 0.8 mm. The backing layer may be a polymer, in particular thermoplastic, based layer and/or a cork layer. Preferably, said backing layer, at least one core layer, preferably each core layer, and said decorative layer are co-extruded layers. The thickness of the back layer is preferably between 1 and 2.5 mm, more preferably between 1.5 and 2.0 mm. The floor covering element thickness may vary but is preferably situated in between 3.5 and 15 mm.

The invention also relates to a decorative covering comprising a plurality of, preferably intercoupled, decorative covering elements according to the invention.

The invention further relates to a method of post-use handling of a recollected decorative covering element, in particular a floor covering element according to the invention, comprising the steps of:
A) subjecting the decorative covering element, in particular the floor covering element, to a heat treatment,
B) pulling apart said core layer and said backing layer to break the tie layer based bonding of said core layer and said backing layer resulting in separation of said core layer from said backing layer.

Preferably, during step A) the floor covering element is subjected to an atmosphere having a temperature of between 80 and 150 degrees Celsius. Preferably, during step A) the floor covering element its is heated to a temperature of at least 80 degrees Celsius.

Steps A) and B) are preferably performed simultaneously. This means that the pulling apart action according to step B) is performed at elevated temperature according to step A).

Preferably, the method comprises step C) comprising the step of recycling the core layer into a new product preferably a new floor covering element. In this new floor covering element, the recollected core layer is typically crushed or milled and, if appropriate, extruded again to form a new core layer. Often, virgin core layer material is admixed with the recycled core layer material prior to preparing the new core layer. Dependent on the formulation of the backing layer, the same principle can be applied to the recollected backing layer which may also be recycled into a new product, such as a new floor covering element, in particular an at least partially recycled backing layer of a new floor covering element.

Preferably, the method comprises step D) comprising the step of separating at least a substantial part of the decorative top structure from the core layer, wherein step D) is preferably performed prior to step C). This step may also take place at elevated temperature and/or by means of milling off (hence mechanically removing) the decorative top structure with respect to the core layer.

### BRIEF DESCRIPTION OF THE DRAWINGS

The terms Fig., Figs., Figure, and Figures are used interchangeably in the specification to refer to the corresponding figures in the drawings.

The invention will be further elucidated by several non-limitative embodiments according to the present invention, wherein:

FIG. 1 schematically shows a cross-sectional view of a decorative covering element according to the invention,

FIG. 2 schematically shows cross-sectional enlarged view of the squared portion A of FIG. 1,

FIG. 3 schematically shows an enlarged view of the core layer, tie layer and backing layer of a decorative covering element according to the invention, and

FIG. 4 schematically shows a method of post-use handling of a recollected decorative covering element according to the invention.

### DESCRIPTION OF THE INVENTION

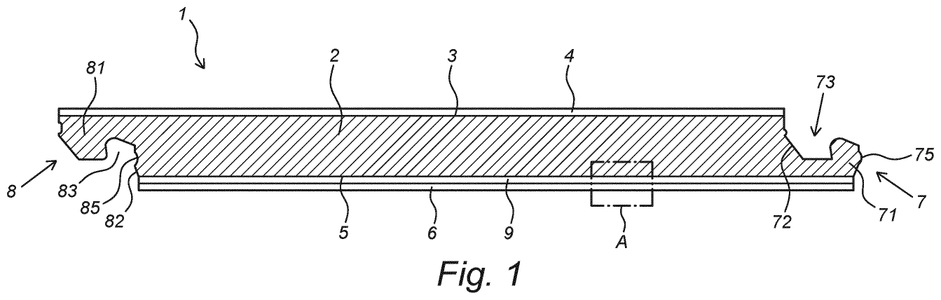

FIG. 1 schematically shows a cross-sectional view of a decorative covering element 1 according to the invention. The decorative covering element 1 can be a decorative floor covering element, a decorative wall covering element or a decorative ceiling covering element. The decorative covering element 1 comprises a core layer 2. On the upper side 3 of the core layer 2 a decorative top structure 4 is, directly or indirectly, affixed. At the lower side 5 of the core layer 2 a backing layer 6 is affixed by means of an intermediate tie layer 9. The tie layer 9 is configured to bind the core layer 2 and the backing layer 6. The tie layer 9 is at least partially hydrogen bonded to the core layer 2 and/or the backing layer 6. The shown decorative covering element 1 further comprises a pair of opposite edge complementary coupling profiles 8, 9 configured to interlock adjacent decorative covering elements. The first coupling profile 8 comprises a downward tongue 81, a downward flank 82 situated at a distance from the downward tongue 81, and a downward groove 83 formed in between the downward tongue 81 and the downward flank 82, wherein the downward groove 83 is adapted to receive at least a part of an upward tongue 71 of the second coupling profile 9 of another decorative covering element. Optionally, a second locking element 85 adapted for co-action with a first locking element 75 of another decorative covering element 1, is provided at the downward flank 82. The second coupling profile 7 comprises an upward tongue 71, an upward flank 72 situated at a distance from the upward tongue and an upward groove 73 formed in between the upward tongue 71 and the upward flank 72, wherein the upward groove is adapted to receive at least a part of a downward tongue 81 of the first coupling part 8 of another decorative covering element 1. A first locking element 75 is provided at an outside of the upward tongue 71 facing away from the upward flank 72.

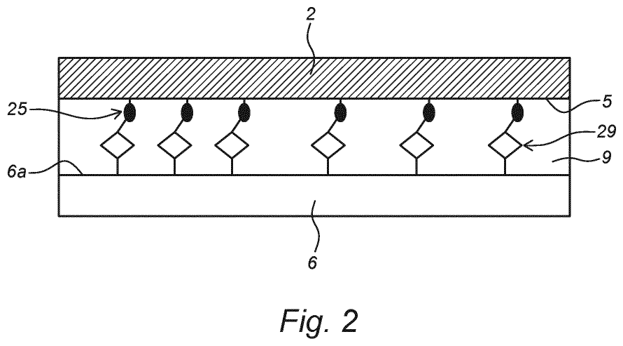

FIG. 2 schematically shows a cross-sectional enlarged view of the squared portion A of a decorative covering element according to FIG. 1. FIG. 2 shows a core layer 2 that is bonded to a backing layer 6 by means of an intermediate tie layer 9. The lower side 5 of the core layer 2 is at least partially functionalised with functional groups 25, in particular a hydroxyl group and/or an amino group. The functional groups 25 are configured to chemically bind to tie layer molecules 29, forming a tie layer based bonding of the core layer 2 and the backing layer 6. It is imaginable that the backing layer 6 is functionalised with tie layer molecules 29, for example by means of grafting. It is conceivable that at least a fraction of the functional groups 25 are configured to form a dipole-dipole interaction with tie layer molecules 29. Preferably, at least a fraction of the functional groups 25 of the core layer 2 are configured to form a hydrogen bond with at least one tie layer molecule 29. It is possible that a fraction of the function groups 25 of the core layer 2 can form a covalent bond with a tie layer molecule 29. It is imaginable that at least a fraction of the tie layer molecules 29 are configured to form a dipole-dipole interaction with the backing layer 6. Preferably, at least a fraction of the tie layer molecules 29 are configured to form a hydrogen bond with the backing layer 6. At least a fraction of the tie layer molecules 29 can be configured to form a covalent bond with the backing layer 6. It is imaginable that the backing layer 6 and/or the core layer 2 are bond by the tie layer 9 through a combination of covalent bond(s) and hydrogen bond(s). Functional groups 25 can be loaded and/or be deposited on the lower side 5 of the core layer 2. However, it is also possible that the core layer 2 comprises a material that is at least partially formed of molecules comprising a functional group 25. The core layer 2 can for example comprise a filler comprising at least one hydroxyl group and/or at least one amino group. It is also imaginable that the core layer 2 comprises particles that are functionalized with at least one functional group 25, such as an hydroxyl group and/or an amino group.

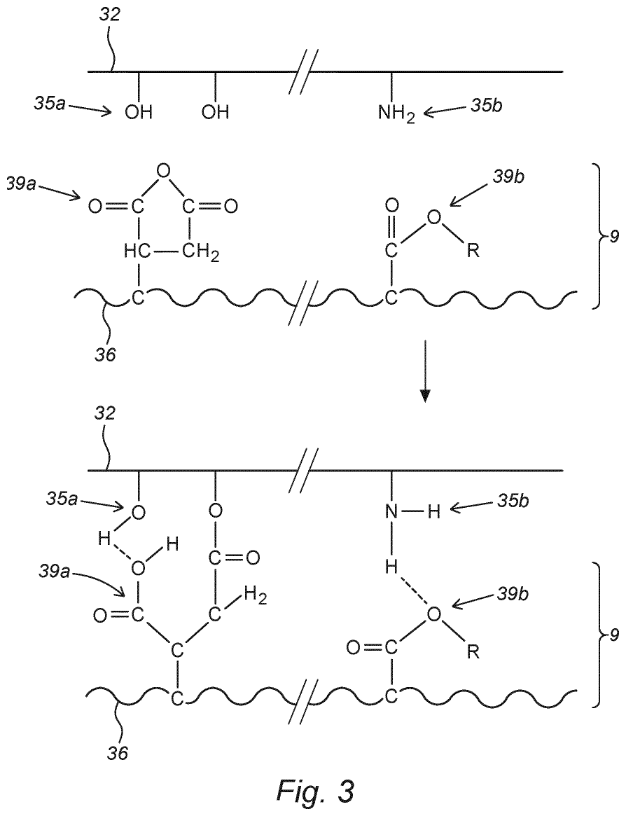

FIG. 3 schematically shows an enlarged view of the core layer 32, tie layer 9 and backing layer 36 of a decorative covering element according to the invention. The shown figure shows two possible chemical configurations of the core layer 32, tie layer 9 and backing layer 36. The two different examples are divided by two diagonal lines in this figure. The upper panel shows a core layer 32 that is not in contact with the tie layer 9 and therefore not bound to the backing layer 36. The lower panel shows a core layer 32 that is bound via an intermediate tie layer 9 to a backing layer 36. The core layer 32 comprises functional groups 35a, 35b. The core layer 2 of this embodiment is either functionalised with two hydroxyl groups 35a or with one amino group 35b. It is however also possible that the core layer 32 is functionalised with calcium carbonate. The core layer 32 is functionalised with at least one functional group 35a, 35b. It is also possible that the core layer 32 is functionalised with a combination of two different functional groups 35a, 35b. The backing layer 36 comprises a polymer onto which a tie layer 9 is grafted. The tie layer 9 comprises tie layer molecules 39a, 39b. It is imaginable that at least a fraction of the tie layer molecules 39a, 39b are grafted onto the polymer of the backing layer 36. In this embodiment, the backing layer 36 is covalently bonded to tie layer molecules 39a, 39b. The polymer of the backing layer 36 in this figures is covalently bounded to a polymaleic anhydride 39a and a polyacrylate 39b for illustrative purposes only. The tie layer 9 can for example comprise of other substances such as a polyacrylate, a polymethacrylate, or a polyanhydride. As can be observed on the lower panel of this figure, there is a hydrogen bond formed between the functional group and the tie layer molecule. More specific, a hydrogen bond is formed between the hydroxyl group 35a and the polymaleic anhydride 39a and between the amino group 35b and the polyacrylate 39b. As a person skilled in the art will understand, is it also possible that the hydroxyl group 35a can form a hydrogen bond with a polyacrylate 39b. It is also possible that a hydrogen bond is formed between the amino group 35b and the polymaleic anhydride 39a. Furthermore, a covalent bond is formed between the hydroxyl group 35a and the polymaleic anhydride 39a.

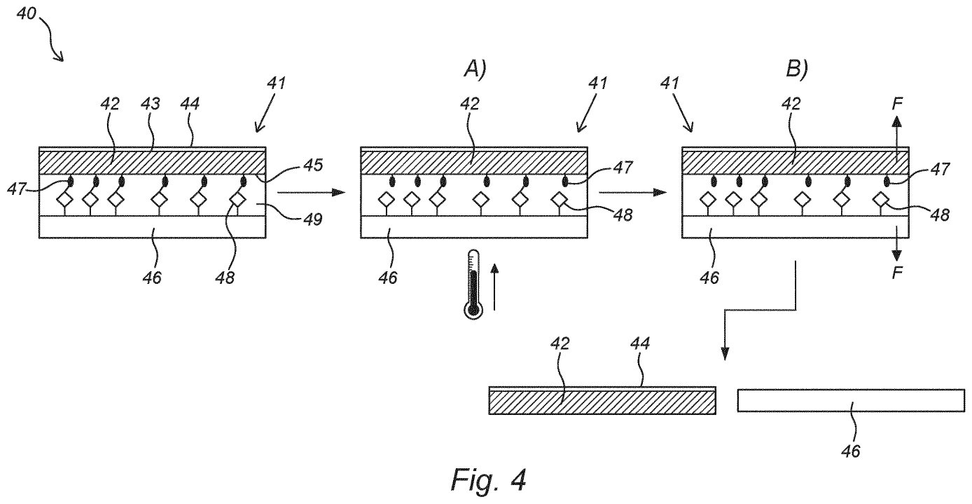

FIG. 4 schematically shows a method 40 of post-use handling of a recollected decorative covering element 41 according to the invention. The decorative covering element 41 comprises a core layer 42. On the upper side 43 of the core layer 42 a decorative top structure 44 is, directly or indirectly, affixed. At the lower side 45 of the core layer 42 a backing layer 46 is affixed by means of an intermediate tie layer 49. The lower side 45 of the core layer 42 is at least partially functionalised with functional groups 47, in particular a hydroxyl group and/or an amino group. The functional groups 47 are bound to tie layer molecules 48. The tie layer 49 is bound to the core layer 42 and the backing layer 46. The tie layer 49 is at least partially hydrogen bonded to the core layer 42 and/or the backing layer 46. The post-use decorative covering element 41 is first subjected to a heat treatment A). Subjecting the decorative covering element 41 to a heat treatment results in at least partially breaking the tie layer based bonding of the core layer 42 and backing layer 46. In particular, subjecting the decorative covering element 41 results in breaking the relatively weak hydrogen bond between either the functional groups 47 of the core layer 42 and the tie layer molecules 48 and/or between the backing layer 46 and the tie layer molecules 48. Preferably, the heat treatment is performed at a temperature between 80-150 degrees Celsius. Subsequently, the core layer 42 and backing layer 46 are pulled apart B) to separate the core layer 42 from the backing layer 46. The core layer 42 and backing layer 46 can for example be pulled apart by applying a mechanical force F. The mechanical force F can be directed in substantially opposite vertical direction with respect to the core layer 42 and backing layer 46. By pulling apart the core layer 42 and backing layer 46, the remaining (non-hydrogen) tie layer based bonding is broken. It is imaginable that the decorative covering element 41 is simultaneously heated A) and pulled apart B). The breaking of the tie layer based bonding of the core layer 42 and backing layer 46 results in the separation of the core layer 42 and the backing layer 46. The separated core layer 42 can subsequently be recycled into a new decorative covering element 41. It is conceivable that backing layer 46, in particular the backing layer material, can also be recycled. Additionally, the decorative top structure 44 can be separated from the core layer 42, preferably before the core layer 42 is recycled.

Hence, the above-described inventive concepts are illustrated by several illustrative embodiments. It is conceivable that individual inventive concepts may be applied without, in so doing, also applying other details of the described example. It is not necessary to elaborate on examples of all conceivable combinations of the above-described inventive concepts, as a person skilled in the art will understand numerous inventive concepts can be (re) combined in order to arrive at a specific application. Various embodiments of the panel as described above and in the appended claims may be combined with this alternative panel configuration.

The ordinal numbers used in this document, like “first” and “second” are used only for identification purposes.

It will be apparent that the invention is not limited to the working examples shown and described herein, but that numerous variants are possible within the scope of the attached claims that will be obvious to a person skilled in the art.

The verb “comprise” and conjugations thereof used in this patent publication are understood to mean not only “comprise”, but are also understood to mean the phrases “contain”, “substantially consist of”, “formed by” and conjugations thereof.

1-31. (canceled)

32. A decorative floor covering element, comprising:
at least one core layer,
a decorative top structure affixed, either directly or indirectly, on an upper side of said core layer,
a backing layer affixed on a lower side of said core layer by means of an intermediate tie layer,
wherein said tie layer is compatible with said core layer and said backing layer, and wherein said tie layer is hydrogen bonded to at least one of said core layer and said backing layer.

33. The decorative floor covering element according to claim 32, wherein the core layer comprises a polymer chosen from the group consisting of: PVC, PET, PETG, PP, PS, thermoplastic polyurethane (TPU), PE, at least one furan resin; and combinations thereof.

34. The decorative floor covering element according to claim 32, wherein the core layer comprises at least one filler at least partially formed of molecules comprising at least one hydroxyl group and/or at least one amino group.

35. The decorative floor covering element according to claim 34, wherein the core layer comprises at least one natural filler at least partially formed of molecules comprising at least one hydroxyl group, wherein at least one of such a natural filler is chosen from the group consisting of: wood, cork, bamboo, hemp, linen, flax, jute, sisal, coconut fibers, banana fibers, cotton, felt, and leather.

36. The decorative floor covering element according to claim 34, wherein the core layer comprises at least one mineral or synthetic filler at least partially formed of molecules comprising at least one hydroxyl group and/or at least one amino group.

37. The decorative floor covering element according to claim 36, wherein the core layer comprises mesoporous silica particles, porous calcium carbonate particles, and/or porous calcium phosphate particles, wherein said particles are loaded with at least one substance comprising at least one amino group and/or at least one hydroxyl group, such as sodium dihydrogen phosphate dihydrate and/or disodium hydrogen phosphate heptahydrate.

38. The decorative floor covering element according to claim 32, wherein at least one side of the tie layer is both hydrogen bonded and covalently bonded to at least one of said core layer and said backing layer.

39. The decorative floor covering element according to claim 38, wherein the covalent bonding between the tie layer and at least one of said core layer and said backing layer is formed by a chemical reaction between the tie layer and at least one of said core layer and said backing layer.

40. The decorative floor covering element according to claim 39, wherein the chemical reaction is partially based upon the transfer of at least one hydrogen atom from said at least one of said core layer and said backing layer, acting as hydrogen donor, to the tie layer, acting as hydrogen acceptor.

41. The decorative floor covering element according to claim 32, wherein said tie layer comprises at least one substance chosen from the group consisting of: a polyanhydride; a polymaleic anhydride; and a copolymer of said polyanhydride or said polymaleic anhydride with either an olefin, an ethyl vinyl acetate, and/or with ethylene acrylate.

42. The decorative floor covering element according to claim 32, wherein said tie layer comprises at least one substance chosen from the group consisting of: a polyacrylate or a polymethacrylate wherein the ester portion thereof has from 1 to about 12 carbon atoms; a blend of said polyacrylate or said polymethacrylate with a polyolefin; ethylene methyl acrylate copolymer.

43. The decorative floor covering element according to claim 32, wherein said backing layer comprises at least one polymer, and wherein at least a fraction of tie layer molecules are grafted onto said polymer of the backing layer.

44. The decorative floor covering element according to claim 43, wherein the amount of tie layer molecules grafted onto the backing layer is at least 1.0% by weight of the backing layer including the grafted tie layer molecules.

45. The decorative floor covering element according to claim 43, wherein the backing layer and the tie layer grafted onto said backing layer form a single layer.

46. The decorative floor covering element according to claim 32, wherein the thickness of the backing layer is 0.2-3 mm.

47. The decorative floor covering element according to claim 32, wherein said backing layer comprises rubber, in particular natural rubber, and wherein said tie layer is bonded to said rubber.

48. The decorative floor covering element according to claim 32, wherein the peel strength of the bonding between the backing layer and the core layer, measured according to the 90° peel test following D6862 (ASTM 2007b), is at least 1.0, 1.5 kN/m.

49. The decorative floor covering element according to claim 32, wherein said tie layer and/or said backing layer has a Vicat softening temperature measured according to method A50 as defined in ISO 306 between 80 and 150 degrees Celsius.

50. The decorative floor covering element according to claim 32, wherein at least one intermediate layer is situated in between said tie layer and said core layer, wherein said intermediate layer comprises a polymer.

51. The decorative floor covering element according to claim 32, wherein the decorative floor covering element comprises at least one decorative surface layer affixed, directly or indirectly, on top of said core layer.

52. The decorative floor covering element according to claim 32, wherein the at least one decorative surface layer is affixed on the upper side of said core layer by means of an intermediate tie layer, wherein said tie layer is compatible with said core layer and said decorative surface layer, and wherein said tie layer is hydrogen bonded, and optionally covalently bonded, to at least one of said core layer and said decorative surface layer.

53. The decorative floor covering element according to claim 32, wherein the tie layer is an extruded layer.

54. The decorative floor covering element according to claim 32, wherein the tie layer and at least of said core layer and said backing layer are coextruded layers.

55. A method of post-use handling of a recollected floor covering element according to claim 32, comprising the steps of:
A) subjecting the floor covering element to a heat treatment,
pulling apart said core layer and said backing layer to break the tie layer based bonding of said core layer and said backing layer resulting in separation of said core layer from said backing layer.
